(19) United States
(12) Patent Application Publication
(10) Pub. No.: US 2002/0114389 A1
(43) Pub. Date: Aug. 22, 2002

(54) COMPRESSING A DIGITAL SIGNAL

(76) Inventors: JOHN PAUL JORDAN, DORSET (GB); ALOIS MARTIN BOCK, HAMPSHIRE (GB)

Correspondence Address: Ladas & Parry, 26 West 61st Street, New York, NY, 10023, US

(21) Appl. No.: 09/048,694

(22) Filed: Mar. 26, 1998

(30) Foreign Application Priority Data
Mar. 27, 1997 (GB) GB9706394.5

(51) Int. Cl. H04N 7/12

(52) U.S. Cl. 375/240.05

(57) ABSTRACT

This invention relates to improvements in compressing digital signals, particularly in buffer management prior to transmission.

This invention provides a method of compressing an input digital signal 10 to produce an output digital signal 13 in a system having a buffer 12. The degree of compression is variable and is controlled according to the occupancy of the buffer 12. The output signal 13 contains a representation of the applied compression within a predetermined range having an upper limit. The input signal may be compressed beyond the upper limit according to the occupancy of the buffer 12 whilst continuing to include a representation of the applied compression in the output signal that is within the predetermined range. One advantage of this method is that the encoder 20 can sustain rapid changes in bit-rate and avoid encoder buffer overflow and hence decoder buffer underflow.

The invention provides a method and apparatus for improving the management of data within the encoder 20 and consequently the decoder 16.

This invention relates to improvements in compressing digital signals, particularly in buffer management prior to transmission.

In the field of digital transmission of data, including broadcasting, it is desirable to compress the data prior to transmission in order to reduce the required bandwidth. Standardising the characteristics of the compressed signal means that the transmitted signal can be received and decompressed by all users in a known manner. One such standard is ISO/IEC 13818, also known as MPEG-2.

A video signal is compressed by removing any spatial or temporal redundancy in the signal, i.e. eliminating any predictability in the source signal. The predictability of a video signal is highly dependent on the image content and so the bit-rate of the compressed signal varies according to the criticality of the image. Criticality is an indication of how difficult an image is to compress.

The compression takes place in an encoder wherein the compressed signal is passed to a buffer prior to transmission. This buffer is used to accommodate a certain amount of bit-rate variation of the compressed signal. The transmitted video signal is received and subsequently passed to a decoder which also contains a buffer to store the compressed signal prior to decompression.

The MPEG-2 standard defines a number of subsets of the syntax and semantics which also define the decoder capabilities required to decode a particular bit-stream. A profile is a defined sub-set of the entire bit-stream syntax that is defined by this MPEG-2 specification. A level is a defined set of constraints imposed on parameters in the bit-stream.

Vital to the delivery of uninterrupted decoded video is the prevention of decoder buffer overflow or underflow. MPEG-2 Main Profile at Main Level (MP@ML) defines a decoder buffer size of 1.8 Mbits, and typically an encoder design will include an encoder buffer of at least the same size. The two buffers form a complementary pair where the total amount of data contained remains constant. This arrangement allows the decoder buffer occupancy to be determined from the encoder buffer and the maintenance of the decoder buffer occupancy can be achieved by ensuring the encoder buffer occupancy remains within the 1.8 Mbit range.

One method for keeping the encoder buffer occupancy within predetermined limits, involves deriving a Quantisation parameter (Qp) from the buffer occupancy. Qp controls the amount of quantisation applied to the video signal and hence varies the compression. In broad terms, the higher the encoder buffer occupancy, the higher the Qp applied. This has the effect of limiting the input bit-rate into the buffer allowing the buffer occupancy to decrease. In order to correctly decompress the received signal, the decoder must know the level of quantisation applied at the encoder. To achieve this, Qp is inserted into the signal and subsequently used by the decoder. The MPEG-2 standard defines the maximum allowable value of Qp that can be sent to a decoder as 31.

This method performs well under most conditions. However, where a significant mismatch exists between the output bit-rate from the encoder buffer and the input bit-rate required to compress a critical video signal, the maximum allowable quantisation may be insufficient to adequately reduce the data rate produced by the compression process. This may lead to encoder buffer overflow and hence decoder buffer underflow.

Accordingly, one object of the present invention is to provide a method and apparatus for improving the management of data within the encoder and decoder buffers.

According to one aspect of the present invention, there is provided a method of compressing an input digital signal to produce a compressed output digital signal in which the degree of compression is variable and is represented in the output signal within a predetermined range having an upper limit, and compressing the input signal beyond the upper limit whilst representing in the output signal that the degree of compression is within the predetermined range.

According to a second aspect of the present invention, there is provided a method of compressing an input digital signal to produce a compressed output digital signal, the method comprising the steps of: applying the input digital signal to a compressor for compressing the input signal; passing the result of compression by the compressor through a buffer to form said output signal; changing the degree of compression applied by the compressor according to the occupancy of the buffer to control the data flow rate through the buffer; including in the output digital signal a representation of the degree of compression applied by the compressor within a predetermined range having an upper limit; and causing the compressor to compress the input signal beyond the upper limit when the occupancy of the buffer has reached a predetermined level whilst continuing to include in the output signal a representation that the degree of compression is within the predetermined range.

According to a third aspect of the present invention, there is provided apparatus for compressing an input digital signal to produce a compressed output digital signal, the apparatus comprising a compressor to compress the input signal to a degree of compression that is variable and is represented in the output digital signal within a predetermined range having an upper limit, and a controller to control the compressor to compress the input signal beyond the upper limit while representing in the output signal that the degree of compression is within the predetermined range.

According to a fourth aspect of the present invention, there is provided apparatus for compressing an input digital signal to produce a compressed output digital signal, the apparatus comprising: a compressor for compressing the input digital signal; a controller to change the degree of compression applied by the compressor according to the occupancy of a buffer to control the data flow through the buffer and to include in the output signal a representation of the degree of compression applied by the compressor within a predetermined range having an upper limit; and the controller being adapted to control the compressor to compress the input signal beyond the upper limit when the occupancy of the buffer has reached a predetermined level while continuing to include in the output signal a representation that the degree of compression is within the predetermined range.

Reference will now be made, by way of example, to the accompanying drawings, in which:

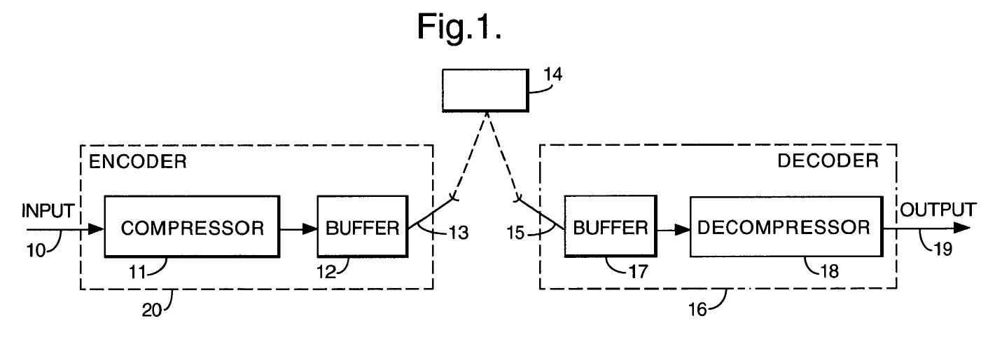

FIG. 1 is a schematic diagram of a broadcasting system according to the present invention; and

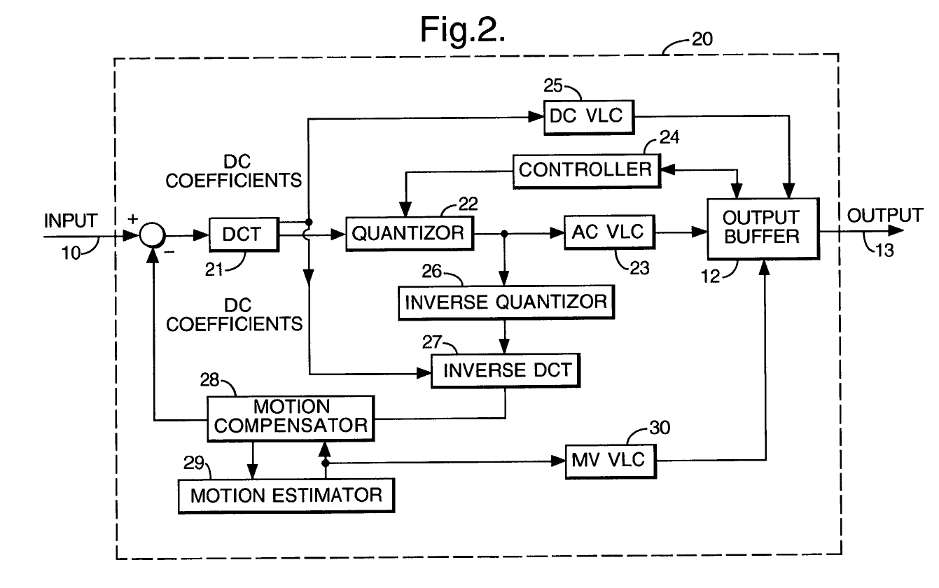

FIG. 2 is a diagram showing an encoder included in the broadcasting system of FIG. 1.

A broadcast system is illustrated in FIG. 1 and includes an encoder 20 and a decoder 16. An input signal 10, such as a video signal is fed to the encoder 20 comprising a compressor 11 and a buffer 12. The video signal 10 is compressed by compressor 11 and passed through the buffer 12 to produce a compressed output digital signal 13. The compressed signal is then transmitted to a receiver 15 where it is subsequently input to a decoder 16 wherein the compressed signal is passed through a buffer 17 before entering the decompressor 18 which produces an uncompressed video signal 19.

In FIG. 1, the transmission from the encoder 20 to the decoder 16 is via a satellite 14, although other means of transmission could also be used such as a cable, terrestrial or data broadcasting network. The buffer 12 in the encoder 20 is required to accommodate the bit-rate variation caused by the compression process and the decoder buffer 17 stores the received compressed data until it is required by the decompressor 18.

An MPEG-2 decoder buffer at Main Profile at Main Level (MP@ML) is limited to 1.8 Mbits. The encoder and decoder buffers, 12 and 17 respectively, form a complementary pair where the total amount of data contained remains constant. The maintenance of the decoder buffer occupancy can therefore be achieved by ensuring the encoder buffer occupancy remains within the 1.8 Mbit range.

FIG. 2 shows a simplified block diagram of an example implementation of the proposed method to improve the management of data in the encoder, in particular to avoid buffer overflow. The video input signal 10 is fed via a subtractor to a forward DCT block 21. After DCT transformation, the signal is split into two paths: the DC coefficients and the AC coefficients. The DC coefficients are fed directly to a DC variable length coder 25 and to an inverse DCT block 27. The AC coefficients are fed to a quantiser 22 before being fed to an AC variable length coder 23 and to an inverse quantiser 26. After inverse quantisation, the AC coefficients are combined with the DC coefficients in the inverse DCT block to generate a reconstructed image for use in the motion compensator 28 and motion estimator 29. The motion compensator 28 passes a motion compensated image to the subtractor to aid in the temporal compression of subsequent images. The motion estimator 29 generates motion vectors which are passed to the motion vector variable length coder 30. The outputs of the DC, AC and motion vector variable length coders, 25, 23 and 30 respectively, are merged to form the input of the encoder buffer 12.

One method for maintaining the encoder buffer occupancy within limits, derives the Quantisation parameter (Qp) in the controller 24 from the buffer occupancy. This value of Qp is used to control the quantiser 22, and is inserted into the compressed output signal 13 for subsequent use at the decoder. In MPEG-2 the maximum allowable value of Qp in the decoder is 31. However, it is sometimes the case that this value is insufficient in the encoder to avoid buffer overflow.

It is important that an MPEG compliant data-stream is maintained at all times. Failure to do this will result in a breakdown in the decoding process and lead to picture degradation or even complete picture loss. Allowing buffer overflow or underflow results in a data-stream which is not MPEG compliant.

This invention is concerned with preventing the occurrence of this rate control problem and therefore ensuring that the data-stream produced is always completely MPEG compliant. The controller 24 detects when the output buffer 12 is approaching overflow. The controller generates a value of Qp that exceeds the maximum allowable limit and applies this to the quantiser 22. This further reduces the data rate by quantising to zero more DCT AC coefficients beyond that which would otherwise have been possible. This value of Qp, although not part of the MPEG-2 specification, is restricted to the encoder and is represented in the output signal 13 within a predetermined range having an upper limit. Compliance to the MPEG-2 standard is achieved by representing the maximum compliant value of Qp in the output signal 13. Furthermore, this compliant value of Qp is used in the inverse quantiser 26. This ensures that the motion compensation is based on the DCT coefficients produced by the decoder.

The result of this ‘over-quantising’ has no real visual impact on a decoder. As the value of Qp reaches its upper limit, the quantisation becomes noticeably coarse and will become visible to the viewer. The decoder is told that the ‘over-quantised’ signal was actually quantised at a lower level, and will therefore reverse quantise the signal according to the level indicated in the data-stream. The decoder will obviously not be able to faithfully reverse quantise the ‘over-quantised’ signal, and this will result in further degradation of the image. However, the visual effect of this is unlikely to be more noticeable than an already heavily quantised picture.

The present invention has particular application in dealing with extreme situations which would normally result in buffer overflow and a non-MPEG compliant stream. In these extreme situations picture degradation is not a major concern, although keeping the data-stream MPEG compliant is of utmost importance.

In extreme circumstances the previous method may still prove inadequate in reducing the data flow into the output buffer 12. This situation is detected by the controller 24 which forces all the AC coefficients to zero in the quantiser 22.

Using the proposed methods of buffer management, the encoder can react to rapid changes in the image criticality and avoid encoder buffer overflow.

1. A method of compressing an input digital signal to produce a compressed output digital signal in which the degree of compression is variable and is represented in the output signal within a predetermined range having an upper limit, and compressing the input signal beyond the upper limit whilst representing in the output signal that the degree of compression is within the predetermined range.

2. A method as claimed in claim 1, including the further step of buffering the compressed signal by use of a buffer, and controlling the degree of compression to control the occupancy of the buffer.

3. A method as claimed in claim 1 or claim 2, wherein the compression of the input digital signal includes quantising coefficients of the input digital signal.

4. A method as claimed in claim 3 which is applied to compressing an input digital signal which is a digital video signal and said coefficients are discrete cosine transform coefficients.

5. A method as claimed in claim 4 including forcing said coefficients to a zero value to contain the data rate of the compressed signal within the capacity of the buffer.

6. A method of compressing an input digital signal to produce a compressed output digital signal, the method comprising the steps of:
applying the input digital signal to a compressor for compressing the input signal;
passing the result of compression by the compressor through a buffer to form said output signal;
changing the degree of compression applied by the compressor according to the occupancy of the buffer to control the data flow rate through the buffer;
including in the output digital signal a representation of the degree of compression applied by the compressor within a predetermined range having an upper limit; and
causing the compressor to compress the input signal beyond the upper limit when the occupancy of the buffer has reached a predetermined level whilst continuing to include in the output signal a representation that the degree of compression is within the predetermined range.

7. Apparatus for compressing an input digital signal to produce a compressed output digital signal, the apparatus comprising a compressor to compress the input signal to a degree of compression that is variable and is represented in the output digital signal within a predetermined range having an upper limit, and a controller to control the compressor to compress the input signal beyond the upper limit while representing in the output signal that the degree of compression is within the predetermined range.

8. Apparatus as claimed in claim 7, including a buffer to buffer the compressed signal, the controller being adapted to control the degree of compression to control the occupancy of the buffer.

9. Apparatus as claimed in claim 7 or claim 8, wherein the compressor is adapted to compress by quantising coefficients of the input digital signal.

10. Apparatus as claimed in claim 9, wherein the compressor is adapted to compress an input digital signal which is a digital video signal and is adapted to quantise discrete cosine transform coefficients of the video signal.

11. Apparatus as claimed in claim 10, wherein the controller is adapted to force said coefficients to zero to contain the data rate of the compressed signal within said buffer means.

12. Apparatus for compressing an input digital signal to produce a compressed output digital signal, the apparatus comprising:
a compressor for compressing the input digital signal;
a controller to change the degree of compression applied by the compressor according to the occupancy of a buffer to control the data flow through the buffer and to include in the output signal a representation of the degree of compression applied by the compressor within a predetermined range having an upper limit; and
the controller being adapted to control the compressor to compress the input signal beyond the upper limit when the occupancy of the buffer has reached a predetermined level while continuing to include in the output signal a representation that the degree of compression is within the predetermined range.

13. A method of transmitting a signal compressed according to the method of any of claims 1 to 6, comprising the further step of reverse quantising the signal at a decoder according to the level of compression represented in the compressed digital signal.

14. A method of compressing an input digital signal to produce a compressed output digital signal, the method substantially as herein described with reference to FIG. 2.

15. Apparatus for compressing an input digital signal to produce a compressed output digital signal, the apparatus substantially as herein described and illustrated in FIG. 2.
